(19) United States
(12) Patent Application Publication
(10) Pub. No.: US 2026/0291570 A1
(43) Pub. Date: Sep. 24, 2026

(54) Improved Channel Estimation, Improved Channel Reconstruction, and Improved Precoder Generation

(71) Applicant: Telefonaktiebolaget LM Ericsson (publ), Stockholm (SE)

(72) Inventors: Rui He, Beijing (CN); Antonios Pitarokoilis, Stockholm (SE)

(21) Appl. No.: 19/475,494

(22) PCT Filed: Mar. 14, 2024
(86) PCT No.: PCT/CN2024/081564

§ 371 Date: Oct. 15, 2025

(30) Foreign Application Priority Data
Apr. 19, 2023 (WO) PCT/CN2023/089303

(51) Int. Cl. H04B 7/06; H04B 7/0456

(52) U.S. Cl. CPC H04B 7/0617; H04B 7/0456; H04B 7/0658

(57) ABSTRACT

The present disclosure is related to network nodes and methods for improved channel estimation, improved channel reconstruction, and improved precoder generation. A method at a BBU comprises: transmitting, to an RU, a message indicating a measurement matrix; receiving, from the RU, a first signal compressed by the RU based on at least the measurement matrix; reconstructing a channel based on at least the first signal; and transmitting, to the RU, a message indicating a precoder for beamforming, which is determined during the reconstruction of the channel.

### CROSS-REFERENCE TO RELATED APPLICATION(S)

This application claims priority to the PCT International Application No. PCT/CN2023/089303, entitled “SIGNAL PROCESSING FOR MULTIPLE-INPUT-MULTIPLE-OUTPUT (MIMO) COMMUNICATION”, filed on Apr. 19, 2023, which is incorporated herein by reference in its entirety.

### TECHNICAL FIELD

The present disclosure is related to the field of telecommunication, and in particular, to network nodes and methods for improved channel estimation, improved channel reconstruction, and improved precoder generation.

### BACKGROUND

With the development of the electronic and telecommunication technologies, mobile devices, such as mobile phones, smart phones, laptops, tablets, vehicle mounted devices, become an important part of our daily lives. To support a numerous number of mobile devices, a highly efficient Radio Access Network (RAN), such as a fifth generation (5G) New Radio (NR) RAN, will be required.

As one of the most important technologies, Multiple-Input-Multiple-Output (MIMO) communication stands as a technology within wireless networks that enables the simultaneous service of multiple users using the same time and frequency resources. This approach involves the deployment of multiple antennas on either the gNB (gNodeB) or the UE (User Equipment), fostering spatial diversity in data transmission for both uplink (UL) and downlink (DL) communication. The resultant spatial diversity significantly enhances network capacity, effectively optimizing frequency spectrum utilization. Furthermore, MIMO technology can mitigate inter-cell and intra-cell interference, thus promoting greater frequency reuse. Given the scarcity of the electromagnetic spectrum, MIMO emerges as a crucial solution for expanding the capacity of wireless communication systems.

One groundbreaking feature differentiating 5th Generation (5G) from the previous Long Term Evolution (LTE) network is the deployment of massive MIMO systems, which entails the installation of a large number of antennas at network nodes. This configuration provides substantial spatial domain multiplexing gain, enriching the capabilities of the communication system.

An advanced antenna system (AAS) comprises an AAS radio and a suite of AAS features. The AAS radio encompasses an antenna array closely integrated with the requisite hardware and software for radio signal transmission and reception. Additionally, it incorporates signal processing algorithms to facilitate the execution of AAS features. In contrast to conventional systems, this solution offers significantly enhanced adaptability and maneuverability, allowing the adjustment of antenna radiation patterns to accommodate rapidly changing traffic and dynamic multi-path radio propagation conditions. Furthermore, it permits the concurrent reception or transmission of multiple signals with distinct radiation patterns.

### SUMMARY

As the number of antennas in the AAS system increases, several challenges emerge, including heightened hardware complexity, considerations regarding the quality and cost of power amplifiers (PAS), and the need for coordinated design between radio unit (RU) and baseband unit (BBU). In legacy systems with a small number of antennas, the volume of information passing through antenna branches and baseband units is constrained. Consequently, these networks rely on frequency-selective digital beamforming, which involves processing the signals received at each antenna element through Inverse Fast Fourier Transform (IFFT)/Fast Fourier Transform (FFT) operations. However, as the number of antennas grows, the quantity of digital bits received from all antenna branches proportionally increases. This places substantial demands on the interface connecting the radio and baseband units, particularly in the context of front haul transmission. In many practical AAS systems, there are bandwidth limitations on the front haul (e.g., C1 interface), restricting the number of bits that can pass through it. In millimeter wave (mmWave) communication systems, where small wavelengths and high path loss characterize wireless channels, integrating a large number of antennas into the AAS system is feasible. To overcome the C1 interface's bandwidth limitation, it becomes necessary to employ data compression techniques on the received data before transferring it to the baseband unit.

In real-world deployment scenarios, the number of propagation paths received from UL (uplink) channels is generally much smaller than the total number of receiving antennas. Thus, there is potential for dimension reduction in the spatial domain, allowing the received signal with a greater number of dimensions to be projected onto a space with a less number of dimensions while preserving essential information.

Contemporary dimension reduction solutions typically employ beam-space transformation to achieve this reduction. The beam space is defined by pre-determined spatial vectors, such as Discrete Fourier Transform (DFT) matrix-based beam space, or by adaptive beam space vectors derived from channel state information estimated from UL reference signals. Dimension reduction is often accomplished by selecting the strongest beam direction based on specific design criteria.

### Compressed Sensing

Compressed sensing (also known as compressive sensing, compressive sampling, or sparse sampling) is a signal processing technique for efficiently acquiring and reconstructing a signal, by finding solutions to underdetermined linear systems.

From the Nyquist-Shannon sampling theorem, if the highest frequency of a real signal is less than half of the sampling rate, then the signal can be reconstructed perfectly. Compressed sensing is a revolutionary technique to make it possible to reconstruct the signal even though the Nyquist-Shannon sampling theorem does not hold, which means that the highest frequency of the signal is more than half of the sampling rate, under the condition that the signal is sparse. A sparse signal has very few coefficients/components that are significant and most of its components are negligible or equal to zero.

In other words, if the signal is sparse, or sparse after transformation into another domain, it is possible to accurately reconstruct it after compressing it using methods of compressed sensing with a certain appropriate dictionary.

Due to hardware limitation of the radio unit, with larger antenna arrays and extended transmission bandwidths, it is difficult to transfer complete channel sounding information in one sounding step. This is because the data rate will be too high to transmit over the interface connecting the radio unit (RU) and the baseband unit (BBU). Consequently, the state of art relies on the beam space reduction. Before the calculation of the receive beamformers, an additional sounding step with limited bandwidth is needed to determine the beam reduction weights. There will be some disadvantages of the existing sounding solution:

1. Complicated hardware design: to get the best beam reduction weights, a specific receiver is needed, by which channel information with full antennas but limited bandwidth can be sounded, as a compromising solution.

2. Significant processing delay: multiple sounding steps cause a significant delay. Two steps are needed for channel sounding and estimation and one step is needed for calculating beamforming weights. Further, during the narrowband transmission of Sounding Reference Signal (SRS) for the calculation of the time domain beamformer, only a small part of the complete transmission bandwidth is sounded. Hence, complete channel state information is acquired either via extrapolation to the bandwidth that was not sounded or, if narrowband SRS frequency hopping is used, via the exploitation of the received signal from prior slots. However, the information obtained in this way might be significantly aged.

Therefore, to address or at least partially alleviate one or more of the above issues, some embodiments of the present disclosure are provided.

According to a first aspect of the present disclosure, a method at a BBU is provided. The method comprises: transmitting, to an RU, a message indicating a measurement matrix; receiving, from the RU, a first signal compressed by the RU based on at least the measurement matrix; reconstructing a channel based on at least the first signal; and transmitting, to the RU, a message indicating a precoder for beamforming, which is determined during the reconstruction of the channel. Further, some other embodiments of the first aspect will be described below with reference to the figures.

According to a second aspect of the present disclosure, a network node hosting a Baseband Unit (BBU) is provided. The network node comprises: a processor; a memory storing instructions which, when executed by the processor, cause the network node to: transmit, to a Radio Unit (RU), a message indicating a measurement matrix; receive, from the RU, a first signal compressed by the RU based on at least the measurement matrix; reconstruct a channel based on at least the first signal; and transmit, to the RU, a message indicating a precoder for beamforming, which is determined during the reconstruction of the channel. In some embodiments, the instructions, when executed by the processor, further cause the network node to perform any of the methods of the first aspect.

According to a third aspect of the present disclosure, a network node hosting a Baseband Unit (BBU) is provided. The network node comprises: a first transmitting module configured to transmit, to a Radio Unit (RU), a message indicating a measurement matrix; a receiving module configured to receive, from the RU, a first signal compressed by the RU based on at least the measurement matrix; a reconstructing module configured to reconstruct a channel based on at least the first signal; and a transmitting module configured to transmit, to the RU, a message indicating a precoder for beamforming, which is determined during the reconstruction of the channel. In some embodiments, the network node comprise one or more further modules, each of which may perform any of the steps of any of the methods of the first aspect.

According to a fourth aspect of the present disclosure, a method at a Radio Unit (RU) is provided. The method comprises: receiving, from a Baseband Unit (BBU), one or more messages indicating a measurement matrix and a precoder for beamforming; obtaining a second signal by using the precoder; determining a first signal by performing random sampling on the second signal with the measurement matrix; and transmitting, to the BBU, the first signal. Further, some other embodiments of the fourth aspect will be described below with reference to the figures.

According to a fifth aspect of the present disclosure, a network node hosting a Radio Unit (RU) is provided. The network node comprises: a processor; a memory storing instructions which, when executed by the processor, cause the network node to: receive, from a Baseband Unit (BBU), one or more messages indicating a measurement matrix and a precoder for beamforming; obtain a second signal by using the precoder; determine a first signal by performing random sampling on the second signal with the measurement matrix; and transmit, to the BBU, the first signal. In some embodiments, the instructions, when executed by the processor, further cause the network node to perform any of the methods of the fourth aspect.

According to a sixth aspect of the present disclosure, a network node hosting a Radio Unit (RU) is provided. The network node comprises: a receiving module configured to receive, from a Baseband Unit (BBU), one or more messages indicating a measurement matrix and a precoder for beamforming; an obtaining module configured to obtain a second signal by using the precoder; a determining module configured to determine a first signal by performing random sampling on the second signal with the measurement matrix; and a transmitting module configured to transmit, to the BBU, the first signal. In some embodiments, the network node comprise one or more further modules, each of which may perform any of the steps of any of the methods of the fourth aspect.

According to a seventh aspect of the present disclosure, a computer program comprising instructions is provided. The instructions, when executed by at least one processor, cause the at least one processor to carry out any of the methods of any of the first aspect and the fourth aspect.

According to an eighth aspect of the present disclosure, a carrier containing the computer program of the seventh aspect is provided. In some embodiments, the carrier is one of an electronic signal, optical signal, radio signal, or computer readable storage medium.

With some embodiments of the present disclosure, the received signal samples during SRS transmission may be compressed such that the compressed channel states can be passed from RU to BBU with interface constraints. Further, with some embodiments of the present disclosure, it can also be guaranteed that the frequency dependent channel state information can be reconstructed based on the compressed data at BBU. By this means, flexibility for beamforming design based on hardware limitation can be provided.

With some embodiments of the present disclosure, the proposed framework is very suitable for time critical scenarios. In some embodiments, there may be two parts of delay reduction, one is that compressed sensing makes it possible to get complete channel information by only one step sounding, and the other is that beamforming weights can be output directly from the reconstructor. By contrast, channel estimation will be firstly output from the estimator and then beamforming weights will then be calculated from the beamformer in the related art.

### BRIEF DESCRIPTION OF THE DRAWINGS

FIG. 1 is a diagram illustrating an exemplary telecommunication network in which improved channel estimation, improved channel reconstruction and/or improved precoder generation is applicable according to an embodiment of the present disclosure.

FIG. 2 is a diagram illustrating an exemplary system for legacy channel estimation/precoder generation and an exemplary system for improved channel estimation/improved channel reconstruction/improved precoder generation according to an embodiment of the present disclosure.

FIG. 3A is a diagram illustrating an exemplary system for legacy coherent Physical Downlink Shared Channel (PDSCH) transmission and an exemplary system for improved coherent PDSCH transmission according to an embodiment of the present disclosure.

FIG. 3B is a diagram illustrating an exemplary system for legacy coherent Physical Uplink Shared Channel (PUSCH) reception and an exemplary system for improved coherent PUSCH reception according to an embodiment of the present disclosure.

FIG. 4 is a diagram illustrating an exemplary procedure for compressed sensing based uplink channel estimation according to an embodiment of the present disclosure.

FIG. 5 is a diagram illustrating exemplary simulation results.

FIG. 6 is a diagram illustrating an exemplary simulation result according to an embodiment of the present disclosure.

FIG. 7 is a diagram illustrating another exemplary simulation result according to another embodiment of the present disclosure.

FIG. 8 is a flow chart illustrating an exemplary method at a BBU according to an embodiment of the present disclosure.

FIG. 9 is a flow chart illustrating an exemplary method at an RU according to an embodiment of the present disclosure.

FIG. 10 schematically shows an embodiment of an arrangement which may be used in any of network nodes according to an embodiment of the present disclosure.

FIG. 11 is a block diagram of an exemplary network node according to an embodiment of the present disclosure.

FIG. 12 is a block diagram of another exemplary network node according to another embodiment of the present disclosure.

### DETAILED DESCRIPTION

Hereinafter, the present disclosure is described with reference to embodiments shown in the attached drawings. However, it is to be understood that those descriptions are just provided for illustrative purpose, rather than limiting the present disclosure. Further, in the following, descriptions of known structures and techniques are omitted so as not to unnecessarily obscure the concept of the present disclosure.

Those skilled in the art will appreciate that the term “exemplary” is used herein to mean “illustrative,” or “serving as an example,” and is not intended to imply that a particular embodiment is preferred over another or that a particular feature is essential. Likewise, the terms “first”, “second”, “third”, “fourth,” and similar terms, are used simply to distinguish one particular instance of an item or feature from another, and do not indicate a particular order or arrangement, unless the context clearly indicates otherwise. Further, the term “step,” as used herein, is meant to be synonymous with “operation” or “action.” Any description herein of a sequence of steps does not imply that these operations must be carried out in a particular order, or even that these operations are carried out in any order at all, unless the context or the details of the described operation clearly indicates otherwise.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below. In addition, language such as the phrase “at least one of X, Y and Z,” unless specifically stated otherwise, is to be understood with the context as used in general to convey that an item, term, etc. may be either X, Y, or Z, or a combination thereof.

The terminology used herein is for the purpose of describing particular embodiments only and is not intended to be limitation of example embodiments. As used herein, the singular forms “a”, “an”, and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. It will be also understood that the terms “connect(s),” “connecting”, “connected”, etc. when used herein, just mean that there is an electrical or communicative connection between two elements and they can be connected either directly or indirectly, unless explicitly stated to the contrary.

Of course, the present disclosure may be carried out in other specific ways than those set forth herein without departing from the scope and essential characteristics of the disclosure. One or more of the specific processes discussed below may be carried out in any electronic device comprising one or more appropriately configured processing circuits, which may in some embodiments be embodied in one or more application-specific integrated circuits (ASICs). In some embodiments, these processing circuits may comprise one or more microprocessors, microcontrollers, and/or digital signal processors programmed with appropriate software and/or firmware to carry out one or more of the operations described above, or variants thereof. In some embodiments, these processing circuits may comprise customized hardware to carry out one or more of the functions described above. The present embodiments are, therefore, to be considered in all respects as illustrative and not restrictive.

Although multiple embodiments of the present disclosure will be illustrated in the accompanying Drawings and described in the following Detailed Description, it should be understood that the disclosure is not limited to the disclosed embodiments, but instead is also capable of numerous rearrangements, modifications, and substitutions without departing from the present disclosure that as will be set forth and defined within the claims.

Further, please note that although the following description of some embodiments of the present disclosure is given in the context of 5G NR, the present disclosure is not limited thereto. In fact, as long as channel estimation, channel reconstruction, and/or precoder generation is involved, the inventive concept of the present disclosure may be applicable to any appropriate communication architecture, for example, to Global System for Mobile Communications (GSM)/General Packet Radio Service (GPRS), Enhanced Data Rates for GSM Evolution (EDGE), Code Division Multiple Access (CDMA), Wideband CDMA (WCDMA), Time Division-Synchronous CDMA (TD-SCDMA), CDMA2000, Worldwide Interoperability for Microwave Access (WiMAX), Wireless Fidelity (Wi-Fi), 4^{th} Generation Long Term Evolution (LTE), LTE-Advance (LTE-A), or 5G NR, 6^{th} generation (6G) mobile system standard, etc. Therefore, one skilled in the arts could readily understand that the terms used herein may also refer to their equivalents in any other infrastructure. For example, the term “terminal device” used herein may refer to a UE, a mobile device, a mobile terminal, a mobile station, a user device, a user terminal, a wireless device, a wireless terminal, an Internet of Things (IoT) device, an Ambient IoT (A-IoT) device, a Zero Energy (ZE) device, or the like. For another example, the term “network node” used herein may refer to a transmission reception point (TRP), a BBU, an RU, a Distributed Unit (DU), a Central Unit (CU), a base station, a base transceiver station, an access point, a hot spot, a NodeB, an Evolved NodeB (eNB), a gNB, a network element, a satellite, an aircraft, or the like.

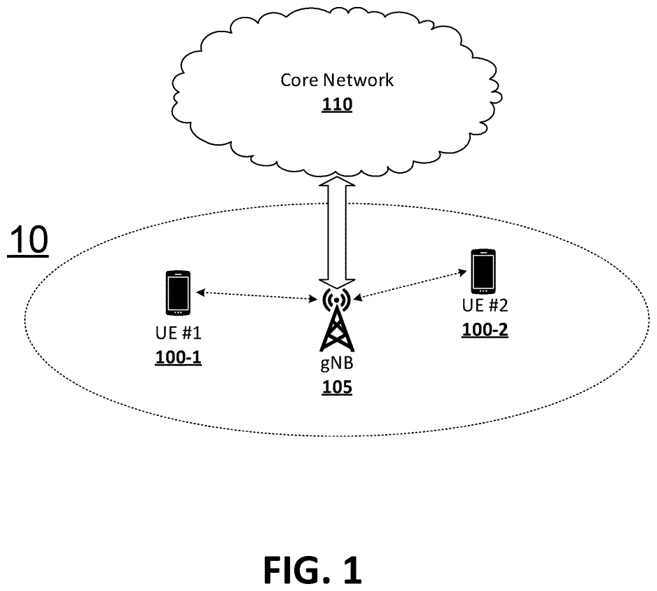

FIG. 1 is a diagram illustrating an exemplary telecommunication network 10 in which improved channel estimation, improved channel reconstruction and/or improved precoder generation is applicable according to an embodiment of the present disclosure. Although the telecommunication network 10 is a network defined in the context of 5G NR, the present disclosure is not limited thereto.

As shown in FIG. 1, the network 10 may comprise one or more UEs 100-1 and 100-2 (collectively, UE(s) 100) and a RAN node 105, which could be a base station, a Node B, an evolved NodeB (eNB), a gNB, or an AN node which provides the UEs 100 with access to the network. Further, the network 10 may comprise a core network (CN) 110 that is communicatively connected to the gNB 105.

However, the present disclosure is not limited thereto. In some other embodiments, the network 10 may comprise additional nodes, less nodes, or some variants of the existing nodes shown in FIG. 1. For example, in a network with the 4G architecture, the entities (e.g., an eNB) which perform these functions may be different from those (e.g., the gNB 105) shown in FIG. 1. For another example, in a network with a mixed 4G/5G architecture, some of the entities may be same as those shown in FIG. 1, and others may be different.

Further, although two UEs 100 and one gNB 105 are shown in FIG. 1, the present disclosure is not limited thereto. In some other embodiments, any number of UEs and/or any number of gNBs may be comprised in the network 10.

As shown in FIG. 1, the UEs 100 may be communicatively connected to the gNB 105 which in turn may be communicatively connected to the CN 110 and then the Internet, such that the UEs 100 may finally communicate its user plane data with other devices outside the network 10, for example, via the gNB 105 and the CN 110.

As mentioned above, due to hardware limitation of the radio unit (e.g., the RU of the gNB 105), with larger antenna arrays and extended transmission bandwidths, it is hard to transfer complete channel sounding information in one sounding step. This is because the data rate will be too high to transmit over the interface connecting the radio unit and the baseband unit (e.g., the BBU of the gNB 105). Consequently, the state of art relies on the beam space reduction. Before the calculation of the receive beamformers, an additional sounding step with limited bandwidth is needed to determine the beam reduction weights. There will be some disadvantages of the existing sounding solution:
Complicated hardware design: to get the best beam reduction weights, a specific receiver is needed, by which channel information with full antennas but limited bandwidth can be sounded, as a compromising solution.
Significant processing delay: multiple sounding steps cause a significant delay. Two steps are needed for channel sounding and estimation and one step is needed for calculating beamforming weights. Further, during the narrowband transmission of SRS for the calculation of the time domain beamformer, only a small part of the complete transmission bandwidth is sounded. Hence, complete channel state information is acquired either via extrapolation to the bandwidth that was not sounded or, if narrowband SRS frequency hopping is used, via the exploitation of the received signal from prior slots. However, the information obtained in this way might be significantly aged.

Therefore, to address or at least partially alleviate one or more of the above issues, some embodiments of the present disclosure are provided.

In some embodiments, an integration framework may be proposed for the AAS system with large number of antennas, for signal compression, reconstruction, estimation, and/or beamforming calculation. In some embodiments, the proposed framework may be composed by at least one of the following components:
1. A reference signal transmission module aims for sending the reference signal from a UE device.
2. A signal compression module which may compress the received signals from all receiving antennas at an AAS frontend.
   2.1 The said compression module may be achieved by a sampling method which creates a number of linear combinations of the received signal from antennas.
   2.2 The number of said linear combinations may be less than the number of the receiving antennas.
   2.3 The said compression module may be applied on the time intervals when the reference signal (of step 1) is transmitted.
   2.4 The compressed signal may be transmitted via an interface with bandwidth constraints.
   2.5 The said compression may be performed on an existing receiving beamforming module.
3. A channel reconstruction module that may recover the channel state information with a certain resolution from the compressed signal (from step 2).
4. Beamforming weights may be generated during reconstruction for the following UL physical channel reception and DL physical channel transmission (from step 3).

Some embodiments of the present disclosure may be summarized as followed:
1. A measurement matrix, generated as a specific precoder, may be adopted to sample data in the antenna domain and to reduce the number of antennas or processing parallels.
2. The said compression precoding is applied in the radio unit on top of reference signal reception such that compressed channel state information may be passed to baseband unit based on C1 interface constraints. In some embodiments, the proposed compression method at the radio unit may be of low complexity.
3. Advanced sparse signal reconstruction algorithms may be adopted to reconstruct the compressed signal to desired resolution and to suppress the noise.
4. Beamforming weights may be generated during reconstruction for the subsequent beamforming procedures of coherent transmission and reception, with a shorter processing delay.

With some embodiments of the present disclosure, the received signal samples during SRS transmission may be compressed such that the compressed channel states can be passed from RU to BBU with interface constraints. Further, with some embodiments of the present disclosure, it can also be guaranteed that the frequency dependent channel state information can be reconstructed based on the compressed data at BBU. By this means, flexibility for beamforming design based on hardware limitation can be provided.

With some embodiments of the present disclosure, the proposed framework is very suitable for time critical scenarios. In some embodiments, there may be two parts of delay reduction, one is that compressed sensing makes it possible to get complete channel information by only one step sounding, and the other is that beamforming weights can be output directly from the reconstructor. By contrast, channel estimation will be firstly output from the estimator and then beamforming weights will then be calculated from the beamformer in the related art.

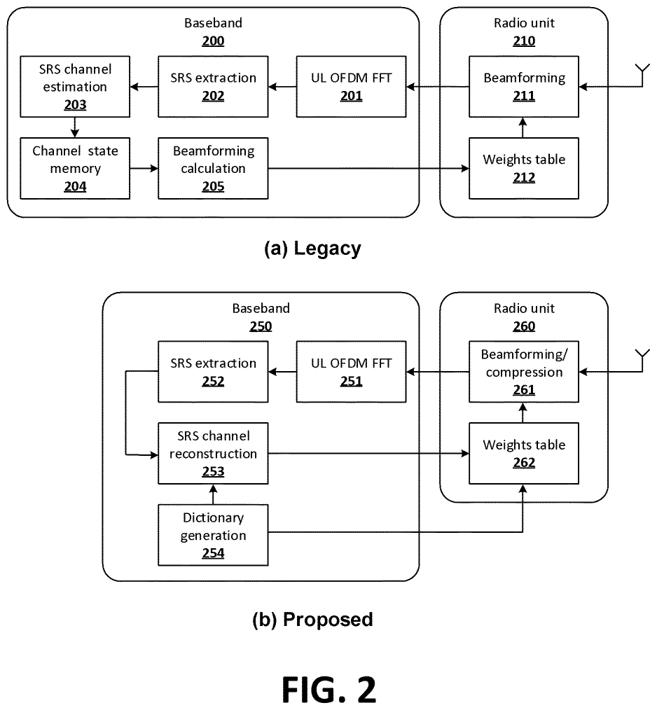

FIG. 2 is a diagram illustrating an exemplary system for legacy channel estimation/precoder generation and an exemplary system for improved channel estimation/channel reconstruction/improved precoder generation according to an embodiment of the present disclosure.

As shown in (a) of FIG. 2, a legacy base station may comprise a baseband unit (BBU) 200 and a radio unit (RU) 210, and UL signals received by the legacy base station may be processed by one or more modules in the BBU 200 and the RU 210 in an order indicated by the arrows shown in (a) of FIG. 2 for legacy channel estimation and precoder generation.

For example, a UL signal carrying SRS transmitted from a UE may be received by an antenna array of the base station, and passed to and processed by a beamforming module 211 of the RU 210. The precoder or the weights for beamforming, which are used by the beamforming module 211, may be generated, selected, or otherwise determined from a weights table 212 based on an indication provided from the BBU 200, and/or the specific precoder or the specific weights for beamforming may be provided from the BBU 200 directly and the weights table 212 may be updated with the provided precoder or weights, as shown in (a) of FIG. 2.

As shown in (a) of FIG. 2, the signal output by the module 211 may be passed from the RU 210 to the BBU 200, and further processed by one or more modules, comprising at least one of (but not limited to):
a UL OFDM FFT module 202 that may convert the signal from the time domain to the frequency domain and demodulate the OFDM symbols in the signal for further analysis;
an SRS extraction module 202 that may extract or otherwise determine the SRS part from the received signal;
an SRS channel estimation module 203 that may estimate the channel based on the extracted SRS signal;
a channel state memory 204 that may store the estimated channel for further processing; and
a beamforming calculation module 205 that may calculate or otherwise determine the precoder or weights to be used for subsequent DL/UL transmission.

As shown in (a) of FIG. 2, the legacy base stations may perform reference signal transmission (e.g., for DL) and reception (e.g., for UL), channel estimation, and consequent beamforming.

By contrast, as shown in (b) of FIG. 2, the solution proposed in some embodiments of the present disclosure may add a dictionary generation module 254 before reference signals reception, a signal compression module 261 that may share the same hardware with the conventional beamforming module (e.g., the beamforming module 211), and an SRS channel reconstruction module 253 into which channel reconstruction, channel estimation, and beamforming weights generation may be embedded. The details of the modules in the BBU 250 and the RU 260 will be provided later.

In some embodiments, the compression in the radio unit 260 may significantly reduce data samples over the C1 interface, the channel estimation complexity, and cost may be transferred to the baseband unit 250, which is more viable since it is more likely that a baseband unit has advanced processing capabilities in comparison to a radio unit. At the same time, channel information from all the antennas and the whole bandwidth can be kept. Furthermore, the proposed random sampling (or signal compression), which will be described later, aims to be operated in the time domain, there is no need to implement OFDM demodulator or band-limited filter in the radio unit, and therefore the hardware complexity may be reduced.

In some embodiments, the proposed signal compression methods may introduce system design flexibility such that a frequency dependent precoder, a wideband precoder, or both can be derived from the reconstructed channel in the baseband unit during reconstruction.

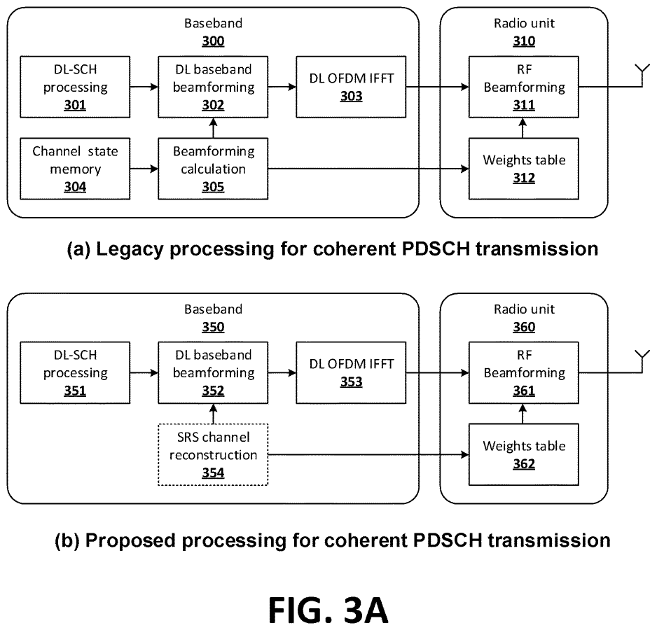

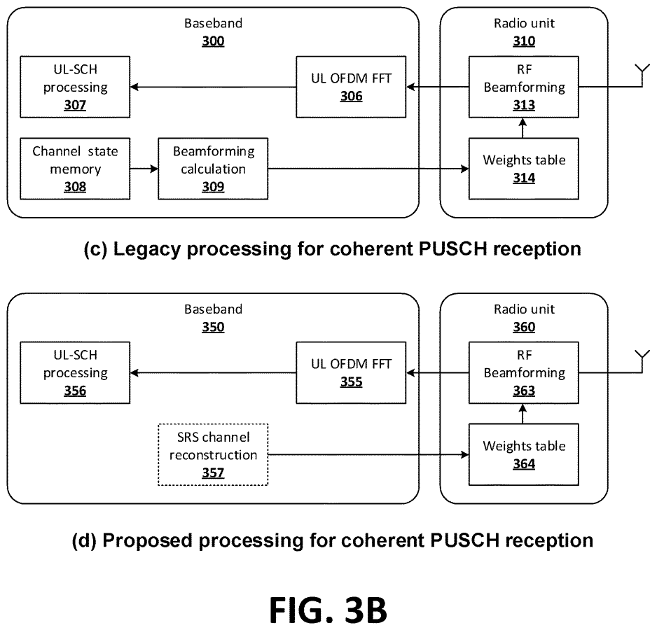

FIG. 3A and FIG. 3B are diagrams illustrating exemplary systems for legacy and improved coherent PDSCH transmission and PUSCH reception according to an embodiment of the present disclosure, respectively.

As shown in (a) of FIG. 3A, a BBU 300 of a legacy base station (e.g., corresponding to the BBU 200 shown in FIG. 2) may perform PDSCH transmission by using a precoder determined in a similar manner to that shown in (a) of FIG. 2. For example, the base station may have one or more modules for performing the PDSCH transmission. As shown in (a) of FIG. 3A, the BBU 300 may comprise at least one of (but not limited to):
a DL-SCH processing module 301 that may process one or more DL-SCH transport channels from an upper layer (e.g., the Medium Access Control (MAC) layer) and derive a PDSCH based thereon;
a DL baseband beamforming module 302 that may perform beamforming on the PDSCH in the digital domain by using a precoder provided by a beamforming calculation module 305;
a DL OFDM IFFT module 303 that may perform an OFDM modulation procedure on the PDSCH, then perform IFFT to convert the OFDM symbols from the frequency domain to the time domain, and send the time domain OFDM symbols to the RU 310 for PDSCH transmission;
a channel state memory 304 that may store the channel state, which is estimated or otherwise determined based on UL and/or DL channel estimation; and
the beamforming calculation module 305 that may calculate or otherwise determine precoders for beamforming in the digital and/or analog domain, and send the precoders to the DL baseband beamforming module 302 and/or the RU 310 for digital and/or analog beamforming, respectively.

In some embodiments, when the channel state is estimated in a way similar to that shown in (a) of FIG. 2, the estimated channel state may be stored in the channel state memory 304, the beamforming calculation module 305 may calculate precoders based on the stored estimated channel state, and provide the precoders and/or an indication thereof to the DL baseband beamforming module 302 and/or the associated RU 310.

As also shown in (a) of FIG. 3A, the RU 310 of the base station may comprise at least one of (but not limited to):
a weights table 312 that may receive an indication and/or specific precoder/weights for beamforming from the beamforming calculation module 305 and generate, select, or otherwise determine a precoder for beamforming, for example, in a similar manner to that shown in (a) of FIG. 2; and
an RF beamforming module 311 that may perform beamforming on the OFDM symbols, which are received from the DL OFDM IFFT module 303, in the analog domain by using the precoder provided by the weights table 312.

By contrast, as shown in (b) of FIG. 3A, a BBU 350 of an improved base station (e.g., corresponding to the BBU 250 shown in FIG. 2) may perform PDSCH transmission by using a precoder determined in a similar manner to that shown in (b) of FIG. 2. For example, the improved base station may have one or more modules for performing the PDSCH transmission. As shown in (b) of FIG. 3A, the BBU 350 may comprise at least one of (but not limited to):
a DL-SCH processing module 351 that may process one or more DL-SCH transport channels from an upper layer (e.g., the MAC layer) and derive a PDSCH based thereon;
a DL baseband beamforming module 352 that may perform beamforming on the PDSCH in the digital domain by using a precoder provided by an SRS channel reconstruction module 354 (e.g., corresponding to the SRS channel reconstruction module 253);
a DL OFDM IFFT module 303 that may perform an OFDM modulation procedure on the PDSCH, then perform IFFT to convert the OFDM symbols from the frequency domain to the time domain, and send the time domain OFDM symbols to the RU 360 for PDSCH transmission; and
the SRS channel reconstruction module 354 that may estimate the channel state, reconstruct the channel, and/or determine the weights or precoders for beamforming in the digital and/or analog domain.

In some embodiments, during the channel estimation similar to that shown in (b) of FIG. 2, the SRS channel reconstruction module 354 may determine the precoders for beamforming in digital and/or analog domains for wideband and/or subband, and provide the precoders to the DL baseband beamforming module 352 and/or the RU 360 for digital and/or analog beamforming, respectively.

As also shown in (b) of FIG. 3A, the RU 360 of the improved base station may comprise at least one of (but not limited to):
a weights table 362 that may receive an indication and/or specific weights/precoder for beamforming from the SRS channel reconstruction module 354 and generate, select, or otherwise determine a precoder for beamforming, for example, in a similar manner to that shown in (b) of FIG. 2; and
an RF beamforming module 361 that may perform beamforming on the OFDM symbols, which are received from the DL OFDM IFFT module 353, in the analog domain by using the precoder provided by the weights table 362.

Referring to FIG. 3B for PUSCH reception, as shown in (c) of FIG. 3B, a BBU 300 of a legacy base station (e.g., corresponding to the BBU 200 shown in FIG. 2) may perform PUSCH reception by using a precoder determined in a similar manner to that shown in (a) of FIG. 2. For example, the base station may have one or more modules for performing the PUSCH reception. As shown in (c) of FIG. 3B, the BBU 300 may comprise at least one of (but not limited to):
a UL OFDM FFT module 306 that may convert the received OFDM symbols from the time domain to the frequency domain and demodulate the OFDM symbols into a PUSCH;
a UL-SCH processing module 307 that may process a PUSCH received from the UL OFDM FFT module 306, determine one or more UL-SCH transport channels based thereon, and provide the one or more UL-SCH transport channels to its upper layer (e.g., the MAC layer) for further processing;
a channel state memory 308 that may store the channel state, which is estimated or otherwise determined based on UL and/or DL channel estimation; and
a beamforming calculation module 309 that may calculate or otherwise determine precoders for beamforming in the digital and/or analog domain, and send the precoders to the RU 310 for analog beamforming.

In some embodiments, when the channel state is estimated in a way similar to that shown in (a) of FIG. 2, the estimated channel state may be stored in the channel state memory 308, the beamforming calculation module 309 may calculate precoders based on the stored estimated channel state, and provide the precoders and/or an indication thereof to the associated RU 310.

As also shown in (c) of FIG. 3B, the RU 310 of the legacy base station may comprise at least one of (but not limited to):
a weights table 314 that may receive an indication and/or specific precoder/weights for beamforming from the beamforming calculation module 309 and generate, select, or otherwise determine a precoder for beamforming, for example, in a similar manner to that shown in (a) of FIG. 2; and
an RF beamforming module 313 that may perform beamforming on the OFDM symbols in the received UL signal in the analog domain by using the precoder provided by the weights table 314, and provide the OFDM symbols to the UL OFDM FFT module 306.

By contrast, as shown in (d) of FIG. 3B, a BBU 350 of an improved base station (e.g., corresponding to the BBU 250 shown in FIG. 2) may perform PUSCH reception by using a precoder determined in a similar manner to that shown in (b) of FIG. 2. For example, the improved base station may have one or more modules for performing the PUSCH reception. As shown in (d) of FIG. 3B, the BBU 350 may comprise at least one of (but not limited to):
a UL OFDM FFT module 355 that may convert the received OFDM symbols from the time domain to the frequency domain and demodulate the OFDM symbols into a PUSCH;
a UL-SCH processing module 356 that may process a PUSCH received from the UL OFDM FFT module 355, determine one or more UL-SCH transport channels based thereon, and provide the one or more UL-SCH transport channels to its upper layer (e.g., the MAC layer) for further processing; and
an SRS channel reconstruction module 357 that may estimate the channel state, reconstruct the channel, and/or determine the weights or precoders for beamforming in the digital and/or analog domain.

In some embodiments, during the channel estimation similar to that shown in (b) of FIG. 2, the SRS channel reconstruction module 357 may determine the precoders for beamforming in digital and/or analog domains for wideband and/or narrowband, and provide the precoders to the associated RU 360.

As also shown in (d) of FIG. 3B, the RU 360 of the improved base station may comprise at least one of (but not limited to):
a weights table 364 that may receive an indication and/or specific weights/precoder for beamforming from the SRS channel reconstruction module 357 and generate, select, or otherwise determine a precoder for beamforming, for example, in a similar manner to that shown in (b) of FIG. 2; and
an RF beamforming module 363 that may perform beamforming on the OFDM symbols in the received UL signal in the analog domain by using the precoder provided by the weights table 364, and provide the OFDM symbols to the UL OFDM FFT module 355.

Please note that although some specific modules of the BBU 300/350 and RU 310/360 are shown in FIG. 3A and FIG. 3B, the present disclosure is not limited thereto. In some other embodiments, the BBU 300/350 and/or the RU 310/360 may comprise more modules, less modules, and/or different modules. For example, a Digital to Analog Converter (DAC) for converting digital data to analog data, an Analog to Digital Converter (ADC) for converting analog data to digital data, one or more power amplifiers (PAS) are not shown in FIG. 3A and FIG. 3B.

Next, a detailed description of an exemplary procedure for channel estimation together with channel reconstruction and precoder generation according to an embodiment of the present disclosure will be provided with reference to FIG. 2.

### Reference Signals Transmission

In some embodiments, a reference signal transmission module (e.g., a module in UE for UL reference signal transmission or a module in BS for DL reference signal transmission) may follow a typical mechanism from the current standard or even the future standard. For example, the network configures the mobile terminal to transmit UL reference signal at the allocated time-frequency resource grids.

Further, although some embodiments herein are described in the context of UL SRS, the present disclosure is not limited thereto. In some other embodiments, other reference signals may also be applicable, for example, UL and/or DL Demodulation Reference Signal (DMRS), UL and/or DL Phase Tracking Reference Signal (PT-RS), Channel State Information Reference Signal (CSI-RS), or the like.

### Signal Compression

As is known that there are only some paths through which the signal can propagate from the UE to the gNB, it is obvious that the channel in angular domain can be approximately sparse, which motivates the use of compressed sensing methods for signal compression at the radio unit, transmission via a band-limited interface, and reconstruction at the baseband unit.

In some embodiments, the signal compression may only focus on the compression of the signal samples received during the transmission of the UL reference signals (e.g., SRS). However, the present disclosure is not limited thereto.

In some embodiments, it is assumed that received OFDM samples for a certain SRS port is S∈ [symbol] , where N and Nₛ denote the number of receiving antennas and the number of samples of received OFDM symbols where SRS is carried, respectively.

In some embodiments, a measurement matrix (MM), φ∈ [symbol] , or so-called a compression precoder or dictionary may be adopted for sounding samples:

$$\tilde{S} = Φ S$$

where M≤N, and in some embodiments, the compressed size M should be much smaller than N.

In some embodiments, there are multiple ways to generate @, such as (but not limited to) a matrix whose entries are independently and normally distributed with the same variance.

In some embodiments, for a polarized antenna array, there could be several ways to compress data over polarizations. One feasible way is to (but not limited to) process data per polarization. In such a case, a matrix

$${Φ}^{′} ∈ {ℂ}^{\frac{M}{2} \times \frac{N}{2}}$$

may be generated firstly for each polarization, whose entries are normally distributed with a mean of 0 and a variance of 1/M, given as:

$${Φ}_{i , j}^{′} \sim 𝒩 ( 0 , \frac{1}{M} )$$

where

$$i = 1 , 2 , … , \frac{M}{2} and j = 1 , 2 , … , \frac{N}{2} ,$$

and [symbol] means the normal distribution.

After that, a complete matrix can be given as:

$$Φ = kron ( [ \begin{matrix}1 & 0 \\ 0 & 1\end{matrix} ] , {Φ}^{′} )$$

where kron( ) means Kronecker product.

### Channel Reconstruction and Estimation

### Match Filtering

In some embodiments, after OFDM demodulation for \tilde{R}, the measured symbols in the frequency domain for SRS is Y∈ [symbol] , where L denotes the number of samples in the frequency domain.

In some embodiments, Y can be used to estimate channel H′∈ [symbol] , by match filtering given as:

$$\begin{matrix}{H}_{mf} = Y {s}^{H} \\ = Φ {H}^{′} {ss}^{H} + n \\ \approx Φ {DH}^{″}\end{matrix}$$

where s∈ [symbol] is the pilot sequence of the transmitted SRS, given as

$$s = [ \begin{matrix}{s}_{1} & & \\ & ⋱ & \\ & & {s}_{L}\end{matrix} ]$$

where D∈ [symbol] is a DFT matrix, H″ is the channel coefficients in the beam and frequency domain, and n is the error due to the noise and interference.

### Domain Transformation

In some embodiments, as the compression is performed only on the first domain, the second domain of Y may be transformed to a sparse representation, such as Discrete Cosine Transform (DCT), given by:

$$H = {H}_{m f} Q$$

where H∈ [symbol] , and Q∈ [symbol] is a transformation matrix, which could be a DCT matrix.

### Reconstruction

In some embodiments, the reconstruction algorithm may be implemented and extended based on Orthogonal Match Pursuit (OMP), which can be summarized as follows.

### Input:

H∈ [symbol] : raw estimation of compression domain and DCT domain from the match filter;
φ∈ [symbol] : measurement matrix;
D∈ [symbol] : transformation matrix for sparsifying the antenna domain;
T: number of iterations.

### Output:

\tilde{H}∈ [symbol] : raw estimation of antenna domain and DCT domain

### Procedure:

1. Initialization
   1) Calculate equivalent measurement matrixes as Ψ=φD^{H} and Ω=Q^{T}, where Q is a DCT matrix.
   2) For polarization k (k=1,2), set R₀=Hₖ, where Hₖ is the k^{th} half of rows of H.
   3) Set (i,j) as the set of coordinates of atoms that are allowed to be selected, (i,j)={(1,1), (1,2), . . . , (M, L)}
2. For iteration t (t=1,2 . . . , T), find the index (iₜ, jₜ) by:

$$( {i}_{t} , {j}_{t} ) = {arg max}_{( i , j ) ∈ A} \frac{\vert 〈 {R}_{t - 1} , {B}_{i , j} 〉 \vert}{{‖ {B}_{i , j} ‖}_{2}}$$

where
   B_{i,j} is defined as an atom

$${B}_{i , j} = {ψ}_{i} {ω}_{j}^{H} ,$$

and ψᵢ ωⱼ are the i^{th} column of Ψ and j^{th} column of Ω, respectively. For an ideal case, Hₖ can be represented by the weighted sum of B_{i,j}, as

$${H}_{k} = {\sum }_{i = 1}^{M} {\sum }_{j = 1}^{P} {\tilde{h}}_{k , i , j} {B}_{i , j} ,$$

where \tilde{h}_{h,i,j} is the entry of the i^{th} row and j^{th} column in \tilde{H}ₖ.
The projection of a matrix R onto B_{i,j} is defined as:

$$\begin{matrix}\frac{〈 R , {B}_{i , j} 〉}{{‖ {B}_{i , j} ‖}_{2}} = \frac{tr ( {RB}_{i , j}^{H} )}{{‖ {ψ}_{i} {ω}_{j}^{H} ‖}_{2}} \\ = \frac{{ψ}_{i}^{H} R {ω}_{j}}{{‖ {ψ}_{i} ‖}_{2} {‖ {ω}_{j}^{H} ‖}_{2}}\end{matrix}$$

where tr(·) is the trace of a matrix.

$$\begin{matrix}tr ( R {B}_{i , j}^{H} ) = tr ( R {ω}_{j} {ψ}_{i}^{H} ) \\ = tr ( {ψ}_{i}^{H} R {ω}_{j} ) \\ = {ψ}_{i}^{H} R {ω}_{j}\end{matrix}$$

where ∥ ∥₂ is the Frobenius norm of a matrix.
3. Remove (iₜ,jₜ) from (i,j).
4. Obtain estimated data vector \tilde{h}ₖ=[\tilde{h}_{k,i}_{₁}_{,j}_{₁}, \tilde{h}_{k,i}_{₂}_{,j}_{₂}, . . . \tilde{h}_{k,i}_{ₜ}_{,j}_{ₜ}]^{T} by solving a least squares problem:

$$\begin{matrix}{\tilde{h}}_{k} = arg {min}_{X} ‖ {H}_{k} - {\sum }_{{t}^{′} = 1}^{t} {h}_{k , {i}_{{t}^{′}} , {j}_{{t}^{′}} {B}_{{i}_{{t}^{′}} , {j}_{{t}^{′}}}} ‖ \\ = {A}^{- 1} b\end{matrix}$$

$$where$$

$$A = [ \begin{matrix}〈 {B}_{{i}_{1} , {j}_{1}} , {B}_{{i}_{1} , {j}_{1}} 〉 & … & 〈 {B}_{{i}_{1} , {j}_{1}} , {B}_{{i}_{1} , {j}_{1}} 〉 \\ ⋮ & ⋱ & ⋮ \\ 〈 {B}_{{i}_{1} , {j}_{1}} , {B}_{{i}_{t} , {j}_{t}} 〉 & … & 〈 {B}_{{i}_{t} , {j}_{t}} , {B}_{{i}_{t} , {j}_{t}} 〉\end{matrix} ]$$

$$b = {( 〈 {H}_{j} , {B}_{{i}_{1} , {j}_{1}} 〉 , … , 〈 {H}_{j} , {B}_{{i}_{t} , {j}_{t}} 〉 )}^{T}$$

and the projection B_{i,j} onto B_{i′,j′} is defined as:

$$\begin{matrix}〈 {B}_{i , j} , {B}_{{i}^{′} , {j}^{′}} 〉 = tr ( {B}_{i , j} {B}_{{i}^{′} , {j}^{′}}^{H} ) \\ = tr ( {φ}_{i} {{ω}_{j}^{H} ( {ψ}_{{i}^{′}} {ω}_{{j}^{′}}^{H} )}^{H} ) \\ = 〈 {ψ}_{{i}^{′}}^{H} {ψ}_{i} 〉 〈 {ω}_{j}^{H} , {ω}_{{j}^{′}} 〉\end{matrix}$$

5. Compute residual

$${R}_{t} = {H}_{k} - Ψ {\tilde{H}}_{k , t} {Ω}^{H}$$

$$where$$

$${\tilde{H}}_{k , t} ( i , j ) = \{ \begin{matrix}{\tilde{h}}_{k , i , j} & ( i , j ) ∈ \{ ( {i}_{{t}^{′}} , {j}_{{t}^{′}} ) , {t}^{′} = 1 , 2 , … , t \} \\ 0 & otherwise\end{matrix}$$

or compute it in an equivalent way:

$${R}_{t} = {H}_{k} - {\sum }_{{t}^{′} = 1}^{t} {\tilde{h}}_{k , {i}_{{t}^{′}} , {j}_{{t}^{′}}} {B}_{{i}_{{t}^{′}} , {j}_{{t}^{′}}}$$

6. Repeat until the configured number of iterations T, and get the reconstructed data:

$${\tilde{H}}_{k} = {R}_{T}$$

7. (Optionally if full channel information is needed,) repeat for both polarizations and get the results, as:

$$\tilde{H} = {D}^{H} [ \begin{matrix}{\tilde{H}}_{1} \\ {\tilde{H}}_{2}\end{matrix} ]$$

In some embodiments, the raw channel estimate which is the result of the reconstruction procedure can be further processed in the DFT Beam/DCT domain, or in the antenna/subcarrier domain via legacy algorithms that can further refine the quality of the channel estimation by performing, e.g., channel order selection, or similar procedures. In some embodiments, the result can then be used for the determination of time-domain beamformers, wideband precoders, or subband precoders. In some embodiments, the estimated channel can be also fused with similar estimates from SRS on other OFDM symbols or from prior slots to form a new estimate that incorporates the propagation channel evolution. In some embodiments, the fusing could be a simple averaging, a more involved weighted averaging of the available channel estimates, or other appropriate approaches that incorporate prior knowledge of the channel fading process.

### Beamforming Weights Calculation

Conventionally, the subsequent procedure is to use the reconstructed channels to calculate beamforming weights for coherent PUSCH reception or PDSCH transmission.

However, the proposed solution in some embodiments can directly output the index from the codebook D rather than an additional calculating processing in order to save computational and time resources.

In some embodiments, wideband weights for one polarization can be directly obtained, without calculating by reconstructed channels, by:

$${W}_{w b} = D ( : , {i}_{b e a m} )$$

where i_{beam} is the set of first N_{beam} different indices selected from iₜ (t=1,2 . . . , T) determined in the above procedure, and N_{beam} is the number of beams.

In some embodiments, subband weights for one polarization at subband f can be also calculated using \tilde{H} by a specific algorithm, such as Singular Value Decomposition (SVD) or DFT sweeping at subband f.

In some cases, a subset of the total estimated beams could be required to be selected. Several criteria can be considered in that case, e.g., sorting the beams in decreasing power, bundling neighboring beams together and select the bundle with the highest power, or other criteria.

### Processing Flow

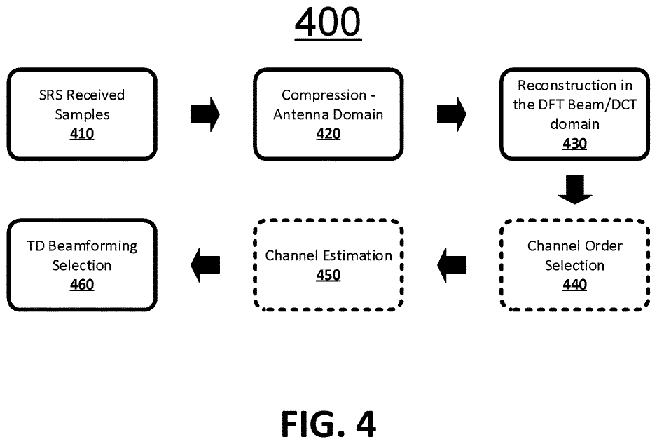

FIG. 4 is a diagram illustrating an exemplary procedure for compressed sensing based uplink channel estimation according to an embodiment of the present disclosure. As shown in FIG. 4, the received samples of the SRS 410 may be compressed as described above in the antenna domain at the block 420 and the channel may be reconstructed in the DFT Beam/DCT domain at the baseband unit at the block 430. At this point, the channel reconstruction can be further processed so that the channel order may be determined at the block 440, and a refined channel estimate may be produced at the block 450. The estimate may be subsequently used for the determination of the time domain (TD) beamformers at the block 460. However, as described above, the information on the DFT Beams obtained during the reconstruction can be directly used for the determination of the TD beamformers. Hence the blocks with the dashed outline could be skipped with the processing flow switching directly to TD beamforming selection. Such a shortcut has an impact on the processing burden and on the latency of the computations.

### Simulation Results

Simulation results are given based on the above proposed solution, which were made in the link-level simulator Brewnix and channel model BEZT. The simulation is coherent PDSCH transmission based the reconstructed channel. Eight wideband beams are determined using the proposed architecture for size reduction, where a narrowband SRS is transmitted, received by a subsampling way and reconstructed as proposed. Some details of the configuration for the simulation are provided in the following table:

| Frequency | 28 | GHz |
|---|---|---|
| Antenna | gNb: 384 (8 × 24 × 2) antennas | |
| | UE: 2 antennas | |
| Subcarrier spacing | 120 | kHz |
| Channel model | BEZT | |
| | San Francisco | |
| Dictionary | Complex Gaussian | |
| Reconstruction | OMP | |
| Method | Processing per polarization | |
| number of measurements | 192 | |
| | (Compression rate ½) | |
| UL-DL power imbalance | 22 | dB |

| | |
|---|---|
| Modulation and coding QAM | Max 256QAM |
| | Max Rank 2 |
| | Inner and outer Link adaption |
| TDD pattern | DDDUU |
| PDSCH BW | 66 Physical Resource Block (PRB) |
| | (100 MHz) |
| SRS configuration | In symbol 13 14 |
| | 66 PRB |

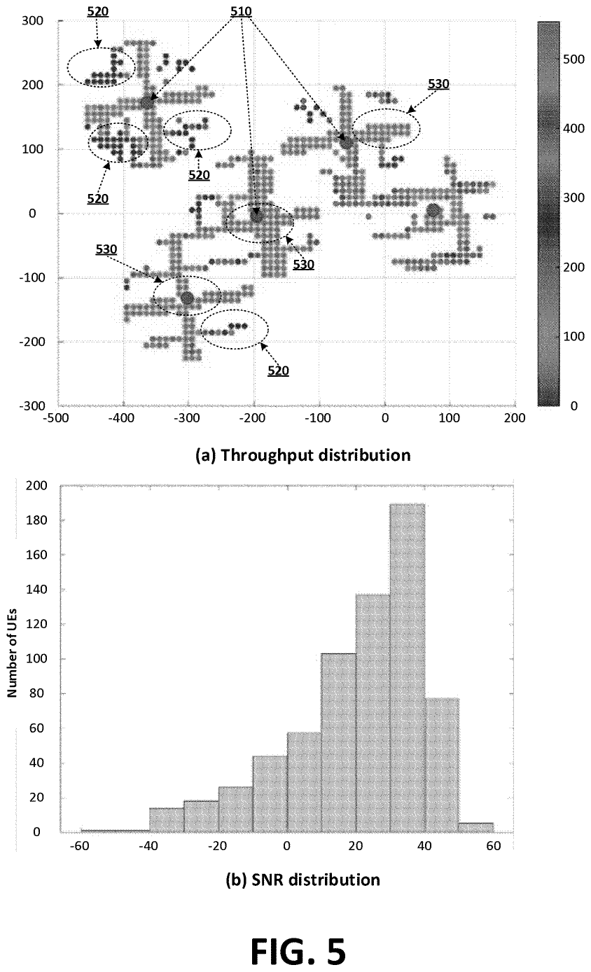

FIG. 5 is a diagram illustrating exemplary simulation results according to an embodiment of the present disclosure, and to be specific, (a) a geographical distribution of throughputs based on the legacy algorithm and (b) its associated SNR distribution of users, when the selected channel model for simulation is BEZT, San Francisco. As shown in (a) of FIG. 5, the coordinates on the x-axis and γ-axis are geographical coordinates. Further, multiple base stations 510 are indicated by the arrows 510, multiple low throughput areas are indicated by the arrows 520, and multiple high throughput areas are indicated by the arrows 530. As shown in (b) of FIG. 5, the coordinates on the x-axis and γ-axis are SNR and number of UEs, respectively.

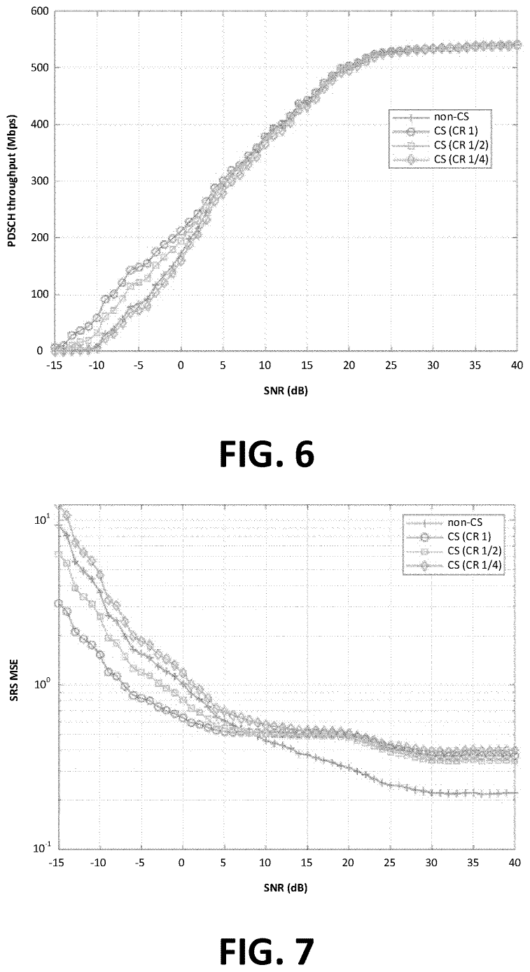

The simulation for the selected channel model has been shown in FIG. 6 and FIG. 7. For the non-CS (or non-compressed-sensing) case, one-step legacy SRS sounding is configured, and its estimation based on the classical DCT estimator will be used for determining hybrid-beamforming precoders. For the compressed sensing cases, compressed sounding with compression ratio

$$1 , \frac{1}{2} , and \frac{1}{4}$$

are respectively configured, where compression ratio is defined as the ratio of the compressed size to the original antenna size. The compression ratio of 1 is an extreme case, with the number of measurements equal to the number of antennas.

With compression ratio of 1 and ½, it obtains a higher throughput than the non-CS case at low SNR as can be seen in the bottom left corner of FIG. 6, which implies a de-noising effect. On one hand, compression will bring noise folding, which literally means noise level will increase like being folded. On the other hand, the distribution of the channel coefficients stands out against that of the noise. Signals are reconstructed from an empty “plane”, which is equivalent to filter noise with weak correlation with measurement matrices. With the compression ratio of ¼, the performance comes to a slightly lower level than the non-CS case at low SNR as also can be seen in the bottom left corner of FIG. 6.

At a medium SNR, the two CS cases obtain slightly lower throughputs than the non-CS case, but the same peak throughput can be obtained at high SNR for all the three cases.

From the perspective of SRS estimation Mean Squared Error (MSE), as shown in FIG. 7, the trend is similar as that of PDSCH throughput. With the compression ratio of ½, compressed sensing improves the estimation performance at low SNR. However, at high SNR, the two CS cases show a convergence floor, which converges at a value larger than 10⁻¹, far worse than that of the non-CS case. The convergence floor can be attributed to how much channel energy the reconstruction algorithms can capture. For low complexity and cost, a relatively low number of iterations, i.e., number of reconstructed coefficients, may be selected. At the same time, true channels are not strictly sparse, but only approximately sparse and usually several weak coefficients can be neglected. Consequently, channel energy will be lost to some degree after the reconstruction.

In some embodiments, the method proposed above could be easily integrated in a cloud infrastructure where the compression can be done as already presented but the reconstruction, or part of it, could be done in the cloud. Consequently, either the whole reconstruction or only the indices to the TD beamforming weight vectors could be signaled to the baseband unit. Also, the indices to the TD beamforming weight vectors could be immediately signaled to the radio unit without the need of a baseband unit.

In some embodiments, the method proposed above may facilitate the splitting of functionality between the radio unit and the baseband unit. Hence, it can easily be implemented within an O-RAN setting. As described, the radio unit may perform the compression, and the compressed signal may be sent to the baseband unit, which could be a device from a vendor different than the one from the radio unit. The reconstruction may be done and the indices to the TD beamforming vectors may be sent to the radio unit for the application during PUSCH reception/PDSCH transmission. The method's implementation may facilitate splitting the functions between the radio unit and the baseband unit, which can be considered the distributed and central unit, respectively. The functions that process the data channels, e.g., PDSCH/PUSCH, may work independently and hence can be easily separated between the radio unit and the baseband unit. For example, the radio unit can combine the samples received from the antenna array using the time domain beams and the result can be independently processed at the baseband unit for symbol detection. The case is similar when processing the SRS signal. However, the presence of the measurement matrix in both the compression and reconstruction steps, which functionally should be placed in the radio unit and baseband unit respectively, can complicate the splitting of the functions.

In some embodiments, the measurement matrix may be generated randomly in this work, which is a popular choice in compressed sensing literature. In some embodiments, the measurement matrix may be essential during both steps of compression and reconstruction. Hence, it must be available at the radio unit and the baseband unit. The complete exchange of the matrix through the interface between the radio unit and the baseband unit is expensive and unnecessary. In some embodiments, the matrix can be generated and stored in (non-volatile) memory separately at the radio unit and the baseband unit. In some other embodiments, it is sufficient to signal the seed between the radio unit and the baseband unit assuming that the same random number generator is implemented in both units. In some embodiments, the type of random number generator might be necessary to be signalled between the radio unit and the baseband unit. Since there are only a handful of such generators, this constraint can be easily implemented. Further, in some embodiments, it is reasonable to assume that during the O-RAN standardization process a couple of basic random number generators will be required to be implemented to ensure interoperability of components from different vendors.

With at least one of the above embodiments, the received signal samples during SRS transmission may be compressed such that the compressed channel states can be passed from RU to BBU with interface constraints. Further, with at least one of the above embodiments, it can also be guaranteed that the frequency dependent channel state information can be reconstructed based on the compressed data at BBU. By this means, flexibility for beamforming design based on hardware limitation can be provided.

With at least one of the above embodiments, the proposed framework is very suitable for time critical scenarios. In some embodiments, there may be two parts of delay reduction, one is that compressed sensing makes it possible to get complete channel information by only one step sounding, and the other is that beamforming weights can be output directly from the reconstructor. By contrast, channel estimation will be firstly output from the estimator and then beamforming weights will then be calculated from the beamformer in the related art.

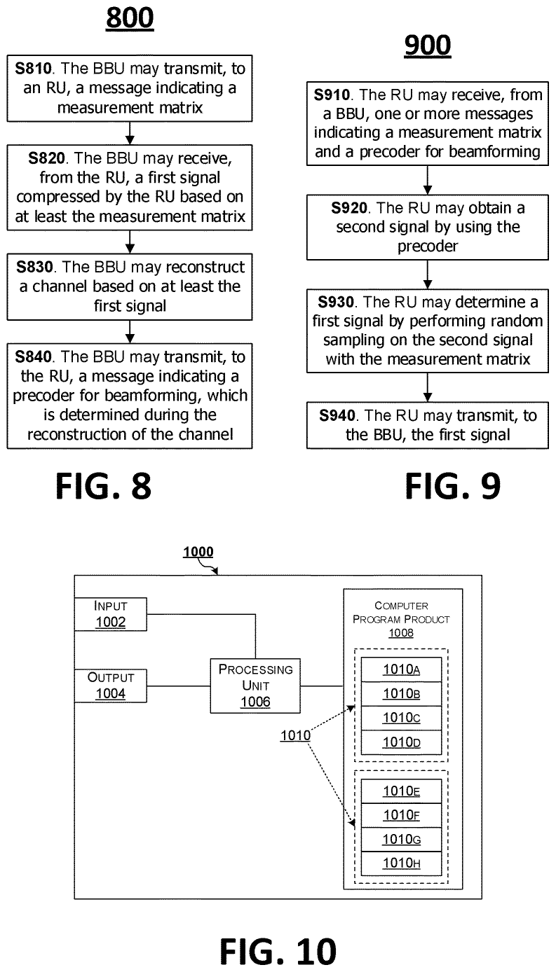

FIG. 8 is a flow chart illustrating an exemplary method 800 at a BBU according to an embodiment of the present disclosure. The method 800 may be performed at a network node (e.g., the BBU 250). The method 800 may comprise steps S810, S820, S830, and S840. However, the present disclosure is not limited thereto. In some other embodiments, the method 800 may comprise more steps, less steps, different steps, or any combination thereof. Further the steps of the method 800 may be performed in a different order than that described herein when multiple steps are involved. Further, in some embodiments, a step in the method 800 may be split into multiple sub-steps and performed by different entities, and/or multiple steps in the method 800 may be combined into a single step.

The method 800 may begin with step S810 where the BBU (or a network node hosting the BBU) may transmit, to an RU, a message indicating a measurement matrix.

At step S820, the BBU (or the network node hosting the BBU) may receive, from the RU, a first signal compressed by the RU based on at least the measurement matrix.

At step S830, the BBU (or the network node hosting the BBU) may reconstruct a channel based on at least the first signal.

At step S840, the BBU (or the network node hosting the BBU) may transmit, to the RU, a message indicating a precoder for beamforming, which is determined during the reconstruction of the channel.

In some embodiments, before the step of transmitting the message indicating the precoder for beamforming, the method 800 may further comprise: determining a codebook for sparsifying the first signal; and determining the precoder based on at least the codebook. In some embodiments, the first signal may be a compressed signal that is compressed by the RU by using random sampling.

In some embodiments, the first signal may be determined by:

$$\tilde{S} = Φ S$$

where \tilde{S} is a complex M-by-Nₛ matrix representing the first signal, S is a complex N-by-Nₛ matrix representing a second signal received by the RU, and the measurement matrix φ is a complex M-by-N matrix for random sampling, where N is the number of receiving antennas, Nₛ is the number of samples of OFDM symbols of the second signal on which a reference signal is carried, and M is the number of measurements and less than N. In some embodiments, a first signal matrix representing the first signal may be determined by multiplying the measurement matrix for random sampling with a second signal matrix representing a second signal that is received by the RU.

In some embodiments, when the second signal is received by the RU from a polarized antenna array, the measurement matrix φ may be defined as:

$$Φ = kron ( [ \begin{matrix}1 & 0 \\ 0 & 1\end{matrix} ] , {Φ}^{′} )$$

where kron(,) is an operator for calculating a Kronecker product, and φ′ is a complex

$$\frac{M}{2} - by - \frac{N}{2}$$

matrix whose elements are independently and normally distributed with a mean of 0 and a variance of 1/M. In some embodiments, when the second signal is received by the RU from a polarized antenna array, the measurement matrix may be defined as a Kronecker product of a 2-by-2 identity matrix and a matrix whose elements are independently and normally distributed with a mean of 0 and a variance of 1/M.

In some embodiments, the step of determining the codebook may comprise: selecting, from a predetermined set of codebooks, the codebook for sparsifying the first signal based on at least a channel model that is currently used by the BBU. In some embodiments, different codebooks in the predetermined set of codebooks may correspond to different channel models, respectively.

In some embodiments, the method 800 may further comprise: demodulating the first signal to obtain a third signal; and estimating a channel based on at least the third signal. In some embodiments, the channel may be estimated by:

$${H}_{m f} = Y {s}^{H}$$

where H_{mf} is a complex M-by-L matrix representing the estimated channel, Y is a complex M-by-L matrix representing the third signal, and s is a complex L-by-L matrix representing a pilot sequence corresponding to the third signal, and s^{H} is the conjugate transpose of s, where L is the number of samples of the third signal in the frequency domain. In some embodiments, the channel may be estimated by multiplying a matrix representing the third signal with a matrix representing a pilot sequence corresponding to the third signal.

In some embodiments, s may be defined by:

$$s = [ \begin{matrix}{s}_{1} & 0 & 0 \\ 0 & ⋱ & 0 \\ 0 & 0 & {s}_{L}\end{matrix} ]$$

$$and$$

$${ss}^{H} = {I}_{L}$$

where {s₁, s₂, . . . , s_{L}} is the pilot sequence and IL is an L-by-L identity matrix.

In some embodiments, the matrix representing the pilot sequence corresponding to the third signal may be a diagonal matrix whose elements on the diagonal form the pilot sequence.

In some embodiments, the method 800 may further comprise: transforming the estimated channel into a sparse representation. In some embodiments, the estimated channel may be transformed by:

$$H = {H}_{m f} Q$$

where H is a complex M-by-L matrix representing the transformed channel, and Q is a complex L-by-L matrix for Discrete Cosine Transform (DCT) transformation. In some embodiments, the estimated channel may be transformed into the sparse representation by multiplying the estimated channel with a DCT transformation matrix.

In some embodiments, the method 800 may further comprise: reconstructing the channel based on at least the transformed channel by using the OMP algorithm. In some embodiments, before the step of reconstructing the channel, the method 800 may further comprise: initializing one or more parameters comprising at least one of a first equivalent measurement matrix, a second equivalent measurement matrix, an initial residual matrix, and an initial set of indices of atoms. In some embodiments, the step of initializing one or more parameters may comprise at least one of: initializing the first equivalent measurement matrix Ψ as Ψ=φD^{H}, where Ψ is a complex M-by-N matrix, D is a complex N-by-N matrix representing the determined codebook; initializing the second equivalent measurement matrix Ω as Ω=Q^{T}, where Ω is a complex L-by-L matrix, and Q^{T} is the transpose of Q; initializing the residual matrix R as R₀=H_{K} where Hₖ is the k^{th} half of rows of H, and k is 1 or 2; and initializing the set of coordinates of atoms as {(1, 1), . . . , (1, L), (2, 1), . . . , (M−1, L), (M, 1), . . . , (M, L)}.

In some embodiments, the step of reconstructing the channel may comprise: iteratively performing following operations until a number of iterations is reached: determining, in the set of coordinates of atoms, a coordinate of an atom that maximizes a projection from the residual matrix onto the atom; updating the set of coordinates of atoms for the next iteration by removing the determined coordinate of the atom from the set of coordinates of atoms; determining an estimated data vector that minimizes the difference between the transformed channel and the inner product of the estimated data vector and corresponding atoms; and updating the residual matrix for the next iteration by setting the residual matrix as the difference between the transformed channel and the inner product of the estimated data vector and corresponding atoms.

In some embodiments, the coordinate of the atom that maximizes the projection from the residual matrix onto the atom may be determined by:

$$( {i}_{t} , {j}_{t} ) = {arg max}_{( i , j ) ∈ A} \frac{\vert 〈 {R}_{t - 1} , {B}_{i , j} 〉 \vert}{{‖ {B}_{i , j} ‖}_{2}}$$

where (iₜ,jₜ) is the coordinate of the atom for the t^{th} iteration, Rₜ₋₁ is the residual matrix from the (t−1)^{th} iteration, B_{i,j} may be an atom defined as:

$${B}_{i , j} = {ψ}_{i} {ω}_{j}^{H}$$

where ψᵢ is the i^{th} column of Ψ, ωⱼ is the j^{th} column of Ω, [symbol] ·,· [symbol] is an operator for calculating an inner product for matrices, |·| is an operator for calculating an absolute value, ∥·∥₂ is an operator for calculating a Frobenius norm, and:

$${arg max}_{x} ( y )$$

is an operator for determining an argument x that maximizes y.

In some embodiments, the estimated data vector that minimizes the difference between the transformed channel and the inner product of the estimated data vector and corresponding atoms may be determined by:

$${\tilde{h}}_{k} = {A}^{- 1} b$$

where \tilde{h}ₖ is the estimated data vector, A and b are defined as:

$$\begin{matrix}A = [ \begin{matrix}〈 {B}_{{i}_{1} , {j}_{1}} , {B}_{{i}_{1} , {j}_{1}} 〉 & … & 〈 {B}_{{i}_{t} , {j}_{t}} , {B}_{{i}_{1} , {j}_{1}} 〉 \\ ⋮ & ⋱ & ⋮ \\ 〈 {B}_{{i}_{1} , {j}_{1}} , {B}_{{i}_{t} , {j}_{t}} 〉 & … & 〈 {B}_{{i}_{t} , {j}_{t}} , {B}_{{i}_{t} , {j}_{t}} 〉\end{matrix} ] \\ b = {( 〈 {H}_{j} , {B}_{{i}_{1} , {j}_{1}} 〉 , … , 〈 {H}_{j} , {B}_{{i}_{t} , {j}_{t}} 〉 )}^{T}\end{matrix}$$

where A⁻¹ is the inverse of A.

In some embodiments, the residual matrix for the next iteration may be updated by:

$${R}_{t} = {H}_{k} - Ψ {\overline{H}}_{k , t} {Ω}^{H}$$

where \tilde{H}_{k,t} is a complex N-by-L matrix that may be defined as:

$${\tilde{H}}_{k , t} ( i , j ) = \{ \begin{matrix}{\tilde{h}}_{k , i , j} & if ( i , j ) ∈ \{ ( {i}_{1} , {j}_{1} ) , … ( {i}_{t} , {j}_{t} ) \} \\ 0 & otherwise\end{matrix} .$$

In some embodiments, the reconstructed channel may be determined by:

$${\tilde{H}}_{k} = {R}_{T}$$

where \tilde{H}ₖ is the reconstructed channel for the k^{th} polarization, and T is the number of iterations.

In some embodiments, the iterations may be performed for both polarizations, and the reconstructed channel may be determined by:

$$\tilde{H} = {D}^{H} [ \begin{matrix}{\tilde{H}}_{1} \\ {\tilde{H}}_{2}\end{matrix} ]$$

where \tilde{H}₁ is the reconstructed channel for the 1^{st} polarization, and \tilde{H}₂ is the reconstructed channel for the 2^{nd} polarization.

In some embodiments, the precoder may be determined by:

$${W}_{wb} = D ( : , {i}_{beam} )$$

where W_{wb} is a complex N-by-N_{beam} matrix representing the precoder, i_{beam} is a set of the first N_{beam} different indices selected from the set {i₁, . . . i_{T}}, N_{beam} is the number of beams, and D (:, i_{beam}) is a matrix composed of the columns of D that are indicated by i_{beam}.

In some embodiments, the precoder may be determined as the columns of the codebook, over which the first signal has more energy than that over the other columns of the determined codebook. In some embodiments, the first signal may be received via an interface between the BBU and the RU. In some embodiments, the interface may have a bandwidth limit.

FIG. 9 is a flow chart illustrating an exemplary method 900 at an RU according to an embodiment of the present disclosure. The method 900 may be performed at a network node (e.g., the RU 260). The method 900 may comprise steps S910, S920, S930, and S940. However, the present disclosure is not limited thereto. In some other embodiments, the method 900 may comprise more steps, less steps, different steps, or any combination thereof. Further the steps of the method 900 may be performed in a different order than that described herein when multiple steps are involved. Further, in some embodiments, a step in the method 900 may be split into multiple sub-steps and performed by different entities, and/or multiple steps in the method 900 may be combined into a single step.

The method 900 may begin with step S910 where the RU (or a network node hosting the RU) may receive, from a BBU, one or more messages indicating a measurement matrix and a precoder for beamforming.

At step S920, the RU (or the network node hosting the RU) may obtain a second signal by using the precoder.

At step S930, the RU (or the network node hosting the RU) may determine a first signal by performing random sampling on the second signal with the measurement matrix.

At step S940, the RU (or the network node hosting the RU) may transmit, to the BBU, the first signal.

In some embodiments, the first signal may be determined by:

$$\tilde{S} = Φ S$$

where \tilde{S} is a complex M-by-Nₛ matrix representing the first signal, S is a complex N-by-Nₛ matrix representing the second signal, and the measurement matrix φ is a complex M-by-N matrix for random sampling, where N is the number of receiving antennas, Nₛ is the number of samples of OFDM symbols of the second signal on which a reference signal is carried, and M is the number of measurements and less than N. In some embodiments, a first signal matrix representing the first signal may be determined by multiplying the measurement matrix for random sampling with a second signal matrix representing the second signal.

In some embodiments, when the second signal is obtained by the RU from a polarized antenna array, the matrix φ may be defined as:

$$Φ = kron ( [ \begin{matrix}1 & 0 \\ 0 & 1\end{matrix} ] , {Φ}^{′} )$$

where kron(,) is an operator for calculating a Kronecker product, and φ′ is a complex

$$\frac{M}{2} - by - \frac{N}{2}$$

matrix whose elements are independently and normally distributed with a mean of 0 and a variance of 1/M. In some embodiments, when the second signal is obtained by the RU from a polarized antenna array, the measurement matrix may be defined as a Kronecker product of a 2-by-2 identity matrix and a matrix whose elements are independently and normally distributed with a mean of 0 and a variance of 1/M.

In some embodiments, the first signal may be transmitted via an interface between the BBU and the RU. In some embodiments, the interface may have a bandwidth limit.

FIG. 10 schematically shows an embodiment of an arrangement 1000 which may be used in network nodes according to an embodiment of the present disclosure. Comprised in the arrangement 1000 are a processing unit 1006, e.g., with a Digital Signal Processor (DSP) or a Central Processing Unit (CPU). The processing unit 1006 may be a single unit or a plurality of units to perform different actions of procedures described herein. The arrangement 1000 may also comprise an input unit 1002 for receiving signals from other entities, and an output unit 1004 for providing signal(s) to other entities. The input unit 1002 and the output unit 1004 may be arranged as an integrated entity or as separate entities.

Furthermore, the arrangement 1000 may comprise at least one computer program product 1008 in the form of a non-volatile or volatile memory, e.g., an Electrically Erasable Programmable Read-Only Memory (EEPROM), a flash memory and/or a hard drive. The computer program product 1008 comprises a computer program 1010, which comprises code/computer readable instructions, which when executed by the processing unit 1006 in the arrangement 1000 causes the arrangement 1000 and/or the terminal device and/or the network node in which it is comprised to perform the actions, e.g., of the procedure described earlier in conjunction with FIG. 2 through FIG. 4, FIG. 8, and FIG. 9 or any other variant.

The computer program 1010 may be configured as a computer program code structured in computer program modules 1010A, 1010B, 1010C, and 1010D. Hence, in an exemplifying embodiment when the arrangement 1000 is used in a network node, the code in the computer program of the arrangement 1000 includes: a module 1010A configured to transmit, to an RU, a message indicating a measurement matrix; a module 1010B configured to receive, from the RU, a first signal compressed by the RU based on at least the measurement matrix; a module 1010C configured to reconstruct a channel based on at least the first signal; and a module 1010D configured to transmit, to the RU, a message indicating a precoder for beamforming, which is determined during the reconstruction of the channel.

Additionally or alternatively, the computer program 1010 may be further configured as a computer program code structured in computer program modules 1010E, 1010F, 1010G, and 1010H. Hence, in an exemplifying embodiment when the arrangement 1000 is used in a network node, the code in the computer program of the arrangement 1000 includes a module 1010E configured to receive, from a BBU, one or more messages indicating a measurement matrix and a precoder for beamforming; a module 1010F configured to obtain a second signal by using the precoder; a module 1010G configured to determine a first signal by performing random sampling on the second signal with the measurement matrix; and a module 1010H configured to transmit, to the BBU, the first signal.

The computer program modules could essentially perform the actions of the flow illustrated in FIG. 2 through FIG. 4, FIG. 8, and FIG. 9, to emulate any of the network nodes. In other words, when the different computer program modules are executed in the processing unit 1006, they may correspond to different modules in any of the network nodes.

Although the code means in the embodiments disclosed above in conjunction with FIG. 10 are implemented as computer program modules which when executed in the processing unit causes the arrangement to perform the actions described above in conjunction with the figures mentioned above, at least one of the code means may in alternative embodiments be implemented at least partly as hardware circuits.

The processor may be a single CPU (Central processing unit), but could also comprise two or more processing units. For example, the processor may include general purpose microprocessors; instruction set processors and/or related chips sets and/or special purpose microprocessors such as Application Specific Integrated Circuit (ASICs). The processor may also comprise board memory for caching purposes. The computer program may be carried by a computer program product connected to the processor. The computer program product may comprise a computer readable medium on which the computer program is stored. For example, the computer program product may be a flash memory, a Random-access memory (RAM), a Read-Only Memory (ROM), or an EEPROM, and the computer program modules described above could in alternative embodiments be distributed on different computer program products in the form of memories within any of the network nodes.

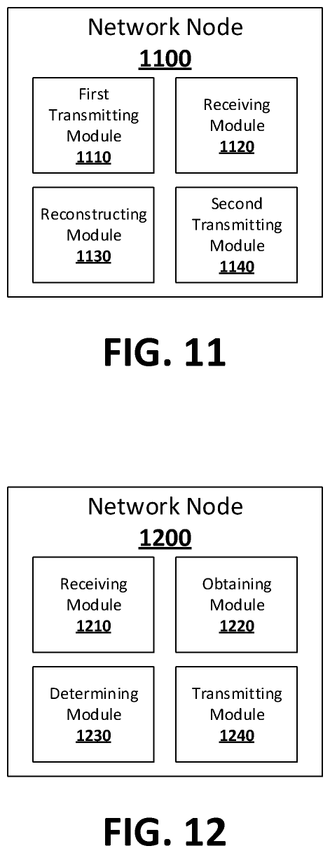

Correspondingly to the method 800 as described above, an exemplary network node is provided. FIG. 11 is a block diagram of a network node 1100 according to an embodiment of the present disclosure. The network node 1100 may be, e.g., the BBU 250 in some embodiments.

The network node 1100 may be configured to perform the method 800 as described above in connection with FIG. 8. As shown in FIG. 11, the network node 1100 may comprise a first transmitting module 1110 configured to transmit, to an RU, a message indicating a measurement matrix; a receiving module 1120 configured to receive, from the RU, a first signal compressed by the RU based on at least the measurement matrix; a reconstructing module 1130 configured to reconstruct a channel based on at least the first signal; and a second transmitting module 1140 configured to transmit, to the RU, a message indicating a precoder for beamforming, which is determined during the reconstruction of the channel.

The above modules 1110, 1120, 1130, and 1140 may be implemented as a pure hardware solution or as a combination of software and hardware, e.g., by one or more of: a processor or a micro-processor and adequate software and memory for storing of the software, a Programmable Logic Device (PLD) or other electronic component(s) or processing circuitry configured to perform the actions described above, and illustrated, e.g., in FIG. 8. Further, the network node 1100 may comprise one or more further modules, each of which may perform any of the steps of the method 800 described with reference to FIG. 8.

Correspondingly to the method 900 as described above, an exemplary network node is provided. FIG. 12 is a block diagram of a network node 1200 according to an embodiment of the present disclosure. The network node 1200 may be, e.g., the RU 260 in some embodiments.

The network node 1200 may be configured to perform the method 900 as described above in connection with FIG. 9. As shown in FIG. 12, the network node 1200 may comprise a receiving module 1210 configured to receive, from a BBU, one or more messages indicating a measurement matrix and a precoder for beamforming; an obtaining module 1220 configured to obtain a second signal by using the precoder; a determining module 1230 configured to determine a first signal by performing random sampling on the second signal with the measurement matrix; and a transmitting module 1240 configured to transmit, to the BBU, the first signal.

The above modules 1210, 1220, 1230, and 1240 may be implemented as a pure hardware solution or as a combination of software and hardware, e.g., by one or more of: a processor or a micro-processor and adequate software and memory for storing of the software, a PLD or other electronic component(s) or processing circuitry configured to perform the actions described above, and illustrated, e.g., in FIG. 9. Further, the network node 1200 may comprise one or more further modules, each of which may perform any of the steps of the method 900 described with reference to FIG. 9.

The present disclosure is described above with reference to the embodiments thereof. However, those embodiments are provided just for illustrative purpose, rather than limiting the present disclosure. The scope of the disclosure is defined by the attached claims as well as equivalents thereof. Those skilled in the art can make various alternations and modifications without departing from the scope of the disclosure, which all fall into the scope of the disclosure.

1-41. (canceled)

42. A method at a Baseband Unit (BBU), the method comprising:
transmitting, to a Radio Unit (RU), a message indicating a measurement matrix;
receiving, from the RU, a first signal compressed by the RU based on at least the measurement matrix;
reconstructing a channel based on at least the first signal; and
transmitting, to the RU, a message indicating a precoder for beamforming, which is determined during the reconstruction of the channel.

43. The method of claim 42, wherein before the step of transmitting the message indicating the precoder for beamforming, the method further comprises:
determining a codebook for sparsifying the first signal; and
determining the precoder based on at least the codebook.

44. The method of claim 42, wherein the first signal is a compressed signal that is compressed by the RU by using random sampling.

45. The method of claim 42, wherein the first signal is determined by:
$$\tilde{S} = Φ S$$
wherein \tilde{S} is a complex M-by-Nₛ matrix representing the first signal, S is a complex N-by-Nₛ matrix representing a second signal received by the RU, and the measurement matrix φ is a complex M-by-N matrix for random sampling, wherein N is the number of receiving antennas, Nₛ is the number of samples of Orthogonal Frequency Division Multiplexing (OFDM) symbols of the second signal on which a reference signal is carried, and M is the number of measurements and less than N.

46. The method of claim 42, wherein a first signal matrix representing the first signal is determined by multiplying the measurement matrix for random sampling with a second signal matrix representing a second signal that is received by the RU.

47. The method of claim 45, wherein the second signal is received by the RU from a polarized antenna array, and the measurement matrix is defined as a Kronecker product of a 2-by-2 identity matrix and a matrix whose elements are independently and normally distributed with a mean of 0 and a variance of 1/M.

48. The method of claim 42, wherein the step of determining the codebook comprises:
selecting, from a predetermined set of codebooks, the codebook for sparsifying the first signal based on at least a channel model that is currently used by the BBU.

49. The method of claim 48, wherein different codebooks in the predetermined set of codebooks correspond to different channel models, respectively.

50. The method of claim 42, further comprising:
demodulating the first signal to obtain a third signal; and
estimating a channel based on at least the third signal.

51. The method of claim 50, wherein the channel is estimated by multiplying a matrix representing the third signal with a matrix representing a pilot sequence corresponding to the third signal.

52. The method of claim 50, further comprising transforming the estimated channel into a sparse representation.

53. The method of claim 52, wherein the estimated channel is transformed into the sparse representation by multiplying the estimated channel with a Discrete Cosine Transform (DCT) transformation matrix.

54. The method of claim 50, further comprising reconstructing the channel based on at least the transformed channel by using the Orthogonal Match Pursuit (OMP) algorithm.

55. The method of claim 54, wherein before the step of reconstructing the channel, the method further comprises:
initializing one or more parameters comprising at least one of a first equivalent measurement matrix, a second equivalent measurement matrix, an initial residual matrix, and an initial set of indices of atoms.

56. The method of claim 54, wherein the step of reconstructing the channel comprises iteratively performing the following operations until a number of iterations is reached:
determining, in the set of coordinates of atoms, a coordinate of an atom that maximizes a projection from the residual matrix onto the atom;
updating the set of coordinates of atoms for the next iteration by removing the determined coordinate of the atom from the set of coordinates of atoms;
determining an estimated data vector that minimizes the difference between the transformed channel and the inner product of the estimated data vector and corresponding atoms; and
updating the residual matrix for the next iteration by setting the residual matrix as the difference between the transformed channel and the inner product of the estimated data vector and corresponding atoms.

57. The method of claim 42, wherein the precoder is determined as the columns of the codebook, over which the first signal has more energy than that over the other columns of the determined codebook.

58. The method of claim 42, wherein the first signal is received via an interface between the BBU and the RU, and wherein the interface has a bandwidth limit.

59. A network node hosting a Baseband Unit (BBU), the network node comprising:
a processor;
a memory storing instructions which, when executed by the processor, cause the network in node to:
transmit, to a Radio Unit (RU), a message indicating a measurement matrix;
receive, from the RU, a first signal compressed by the RU based on at least the measurement matrix;
reconstruct a channel based on at least the first signal; and
transmit, to the RU, a message indicating a precoder for beamforming, which is determined during the reconstruction of the channel.

60. A method at a Radio Unit (RU), the method comprising:
receiving, from a Baseband Unit (BBU), one or more messages indicating a measurement matrix and a precoder for beamforming;
obtaining a second signal by using the precoder;
determining a first signal by performing random sampling on the second signal with the measurement matrix; and
transmitting, to the BBU, the first signal.

61. The method of claim 60, wherein a first signal matrix representing the first signal is determined by multiplying the measurement matrix for random sampling with a second signal matrix representing the second signal.
